(19) United States
(12) Patent Application Publication
(10) Pub. No.: US 2021/0405201 A1
(43) Pub. Date: Dec. 30, 2021

(54) THREE-DIMENSIONAL IMAGING METHOD

(71) Applicant: THE REGENTS OF THE UNIVERITY OF COLORADO, A BODY CORPORATE, DENVER, CO (US)

(72) Inventors: KELVIN H. WAGNER, BOULDER, CO (US); DANIEL FELDKHUN, BOULDER, CO (US); NATHAN DOSTART, LITTLE ROCK, AR (US)

(21) Appl. No.: 17/359,492

(22) Filed: Jun. 25, 2021

Related U.S. Application Data
(60) Provisional application No. 63/044,315, filed on Jun. 25, 2020.

(51) Int. Cl. G01S 17/894; G01S 7/481; G01S 7/48

(52) U.S. Cl. CPC G01S 17/894; G01S 7/4808; G01S 7/4811

(57) ABSTRACT

A range-resolved imaging method includes sampling a plurality of 3D Fourier components of a target with a plurality of frequency-shifted beams that pair-wise interfere at the target. Each of the plurality of frequency-shifted beams has been emitted by a respective transmitter of a sparse transmitter-array. The method also includes extracting amplitudes and phases of temporal oscillations of a detected signal back-scattered by the target in response to the pair-wise interference of the plurality of frequency-shifted beams. The amplitudes and phases correspond to selected 3D Fourier components of a plurality of temporal Fourier components of the detected signal. The method also includes assembling the amplitudes and the phases in a 3D spatial-frequency representation; and producing a range-resolved image of the target via Fourier synthesis of the 3D Fourier representation.

### CROSS-REFERENCE TO RELATED APPLICATION

This application benefits from and claims priority to U.S. provisional patent application Ser. No. 63/044,315, filed on Jun. 25, 2020, the disclosure of which is incorporated herein by reference in its entirety.

### SUMMARY OF THE EMBODIMENTS

In a first aspect, a range-resolved imaging method is disclosed. The method includes steps of illuminating an object, detecting a time-varying signal, extracting amplitudes and phases, and producing a range-resolved image. The illuminating step includes illuminating an object with a plurality of mutually coherent beams produced by an emitter array to produce a plurality of traveling-wave interference fringes that illuminate the object. Each of the plurality of mutually coherent beams being at least one of (a) shifted in frequency within a collective bandwidth of the emitter array, (b) encoded with a maximal length pseudorandom (PN) code time-shifted by a respective one of a plurality of time-shifts (c) encoded with a respective one of a plurality of codes. The product of any two of the plurality of codes is a distinct code.

The detecting step includes detecting a time-varying signal backscattered by the object in response to illumination by the plurality of mutually coherent beams. The extracting step includes extracting amplitudes and phases of at least one of (i) interferometric temporal beat note oscillation frequencies of the time-varying signal and (ii) circulant complex code correlations of the time-varying signal. The amplitudes and phases correspond to selected Fourier components of the object's 3D Fourier representation.

The producing step includes producing a range-resolved image of the object by applying a complex-valued weight to each of the selected Fourier components and applying a Fourier synthesis method to the weighted Fourier components. The range-resolved image having a depth resolution substantially determined by the collective bandwidth and a transverse resolution substantially determined by a maximum spatial separation between any two of a plurality of emitters of the emitter array.

In a second aspect, a range-resolved imaging method includes sampling a plurality of 3D Fourier components of a target with a plurality of frequency-shifted beams that pair-wise interfere at the target. Each of the plurality of frequency-shifted beams has been emitted by a respective transmitter of a sparse transmitter-array. The method also includes extracting amplitudes and phases of temporal oscillations of a detected signal back-scattered by the target in response to the pair-wise interference of the plurality of frequency-shifted beams. The amplitudes and phases correspond to selected 3D Fourier components of a plurality of temporal Fourier components of the detected signal. The method also includes assembling the amplitudes and the phases in a 3D spatial-frequency representation; and producing a range-resolved image of the target via Fourier synthesis of the 3D Fourier representation.

In a third embodiment, a range-resolved imager is disclosed. The imager includes an emitter array, a detector, a processor, and a memory. The emitter array illuminates a scene with a plurality of mutually coherent beams. The detector detects a backscattered signal scattered by an object in the scene and propagating toward the detector. The memory stores machine readable instructions that when executed by the processor, control the processor to execute the method of either the first aspect or the second aspect.

### BRIEF DESCRIPTION OF THE FIGURES

FIG. 1 illustrates (a) a schematic of SOPA tile topology, (b) coarse (slow) wavelength steering, (c) fine (fast) wavelength steering, and (d) diffraction of coarse steering, and (e) diffraction of fine steering.

FIG. 2 illustrates an example of a 2D emitter array with N-element NRA of tiles embedded therein, in embodiment.

FIG. 3 includes example plots a Golomb ruler of frequencies, each of which may be a carrier frequency of tiles of the emitter array of FIG. 2.

FIG. 4 is a plot of a 3D autocorrelation function, which is a set of 3D spatial frequencies sampled by emitter array of FIG. 2 as determined by the temporal frequencies of each beam emitted by tiles thereof, in embodiments.

FIG. 5 is a schematic of a spatial nonredundant array and the first four elements of a transmission-frame sequence of frequency-encoded mutually coherent beam arrays emitted from a tile array, in an embodiment.

FIG. 6 illustrates noise reduction of a spatio-temporal impulse response via accumulating just eight flipped and permuted transmission frames of FIG. 5, in an embodiment.

FIG. 7 illustrates noise reduction of a 2D-spatial impulse response via accumulating just eight flipped and permuted transmission frames of FIG. 5, in an embodiment.

FIG. 8 is a heatmap of a spatial autocorrelation 800 of an average of the transmission-frame sequence of FIG. 5, in an embodiment.

FIG. 9 is a schematic of a structured illumination technique, in embodiments.

FIG. 10 illustrates back scatter, from a sinusoidal component of a 3D object, of interfering beams produced by a pair of frequency shifted tiles, in an embodiment.

FIG. 11 is a one-dimensional cross-section of the back scatter of FIG. 10 at a later time after the back-scattered wave has propagated back to the detector and generated a temporally oscillating signal, in an embodiment.

FIG. 12 illustrates example Golomb rulers with between 5 and 12 frequencies.

FIG. 13 are shows Golomb rulers, their autocorrelations, and corresponding ranging impulse responses for a number of transmit tones, in an embodiment.

FIG. 14 illustrates a plurality of frequency-shifted tones and coherently detected beat notes thereof, in an embodiment.

FIG. 15 is a schematic block diagram of a range-resolved imager, in an embodiment.

FIG. 16 is a flowchart illustrating a first range-resolved imaging method, in an embodiment.

FIG. 17 is a flowchart illustrating a method for generating two beams of the plurality of mutually coherent beams and pair-wise interfering them, in an embodiment.

FIG. 18 is a flowchart illustrating a second range-resolved imaging method, in an embodiment.

### DETAILED DESCRIPTION OF THE EMBODIMENTS

### Serpentine Optical Phased Arrays (SOPAs)

A serpentine optical phased array (SOPA) produces two-dimensional optical beam steering by using an aperture-integrated delay-line ‘feed network’ that in principle requires zero electrical power and nearly zero excess footprint. It is this feature that makes the SOPA extraordinarily easy to operate and suitable to be tiled into large arrays.

An integrated OPA consists of a two-dimensional array of radiating elements with a ‘feed network’ that distributes optical power to the elements and controls the phase of their emission for beam forming and steering. The architecture of the feed network determines the OPA's control complexity, footprint, and ultimately its scalability. Purely electronic phase control, where every radiating element is preceded by an independently-controllable phase-shifter, requires large numbers of phase-shifters. Frequency-based phase control uses dispersive grating couplers, delay lines, or both to map the wavelength to beam emission angle according to a frequency-dependent phase (time delay), which avoids phase-shifters entirely but ‘hard-wires’ the steering control to the OPA design. Most OPAs demonstrated to-date have used purely electronic steering or replaced one dimension of steering control with wavelength by using an array of waveguide-gratings, each fed by a split and phase-shifted copy of the input signal. However, the presence of electronically-controlled phase-shifters within the OPA rapidly increases the OPA's complexity as it increases in size, making centimeter-scale apertures difficult to control.

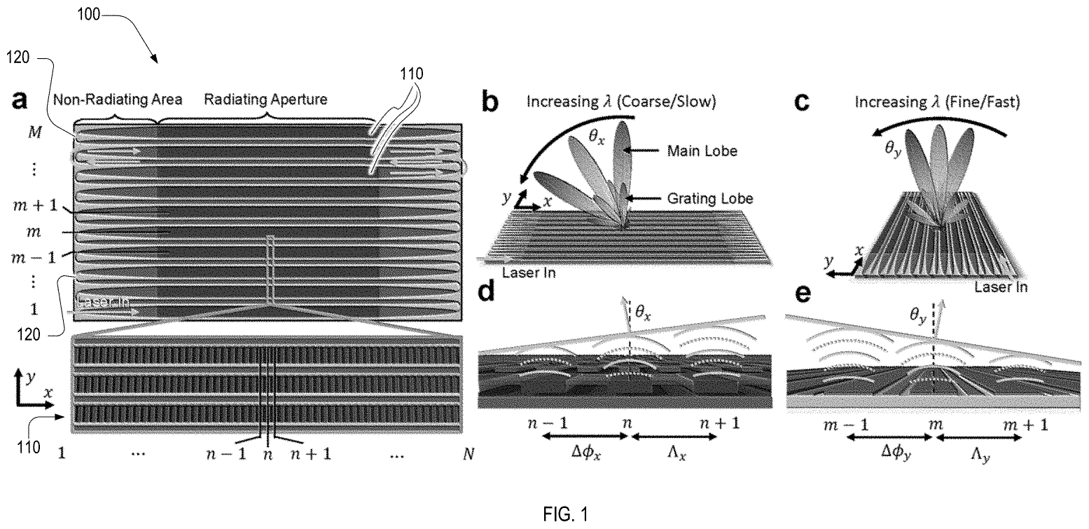

FIG. 1 illustrates a serpentine optical phased array for 2D wavelength steering. FIG. 1(a) is a schematic of a SOPA tile 100, herein also referred to as a SOPA beam steering tile. An array of M rows of grating waveguides 110 are serially connected by flyback waveguides 120 in a serpentine configuration to form a serpentine delay line. Each row has N grating periods.

The key to the SOPA concept is to steer with wavelength in both dimensions by using grating couplers 110 in one dimension (x in FIG. 1(a)) and a sequential folded serpentine delay line in the other (y in FIG. 1(a)). This allows the frequency of a single tunable laser to control the entire OPA, eliminating the need for phase-shifters entirely. To make the SOPA as simple and space-efficient as possible, gratings 110 are incorporated directly into the delay line by means of a serpentine structure.

Thus, unlike the initial 2D wavelength steered OPA approach that used delay lines external to the gratings, the SOPA's delay line ‘feed network’ incurs near zero area overhead and is independent of aperture size. In embodiments, SOPA demonstrates improved performance compared to the previous 2D wavelength-steered OPA: a 400×larger aperture and 300×more spots, enabling performance comparable to the state-of-the-art. This is achieved through development of ultra-low loss components in this work and optimal use of the frequency domain (each addressable spot takes up only as much bandwidth as needed for the desired ranging resolution). By removing the need for phase-shifters, and efficient use of wavelength as an easily accessible control parameter, many SOPA devices may be arrayed on a single chip to create centimeter-scale apertures which drastically outperform other OPA approaches.

The serpentine delay structure steers beams in two orthogonal dimensions by tuning the wavelength/frequency in respectively coarse and fine increments, as illustrated in FIG. 1b, c analogous to a falling raster demonstrated previously with dispersive reflectors in a free-space configuration.

FIGS. 1(b) and 1(c) illustrate coarse (slow) wavelength steering and fine (fast) wavelength steering respectively. For coarse steering along θₓ, each grating waveguide diffracts light to an angle determined by the wavelength-dependent tooth-to-tooth phase delay, as shown in FIG. 1(d). For fine steering along y, the array of gratings diffracts light to an angle determined by the wavelength-dependent row-to-row phase delay, as shown in FIG. 1(e).

The SOPA's beam steering capability is best understood in terms of the frequency-resolvability of the array, which relates the time delay across the aperture to the frequency shift required to steer by one spot. The delay accumulated along a single grating-waveguide (τ) is exactly the inverse of the frequency step (Δf=1/x) required to steer the beam by one resolvable spot along the grating-waveguide dimension θₓ (FIG. 1d). The delay accumulated across the M serpentine rows of the aperture may be defined as T=MCτ, where C is a scaling factor that denotes the ratio of time delay accumulated between rows relative to the single-pass time delay through a grating [C=(τ+τ_{flyback}+2τ_{bend}+4τₜₐₚₑᵣ)/τ]. For an ideal 2D SOPA raster, C=1. The increased delay across all M rows relative to the delay within a grating therefore results in a ‘finer’ (smaller) frequency step to steer by one resolvable spot along θ_{y} (FIG. 1e) than the ‘coarse’ (large) step needed to steer along θₓ. This arrangement causes the beam to steer quickly along θ_{y} and slowly along θₓ for a linear ramp of the optical frequency. The slow scan along θₓ combined with the periodic resetting of the steering angle along θ_{y} as the row-to-row phase increments by 2π results in a 2D raster scan of the FOV controlled entirely by the frequency/wavelength.

A mathematical model for 2D beam steering with frequency is obtained by considering the SOPA as a phased array. Along x, light is coupled out at an angle θₓ(f) through a phase matching condition of equation (1).

$$\begin{matrix}{θ}_{x} ( f ) = {sin}^{- 1} ( \frac{c}{2 π f} [ \frac{Δ {ϕ}_{x} ( f )}{{Λ}_{x}} + q \frac{2 π}{{Λ}_{x}} ] ) , q ∈ ℤ \\ = {sin}^{- 1} ( {n}_{eff} ( f ) - \frac{c}{f {Λ}_{x}} )\end{matrix} \qquad ( 1 )$$

where Λₓ is the grating period, n_{eff} is the effective index of the waveguide mode, q is the diffraction order, and Δϕₓ(f) is the relative phase between grating periods and is given by Δϕₓ(f)=2πfn_{eff}(f)Λₓ/c. We choose the grating period so that only the first diffraction order, q=−1, is radiating.

The diffraction angle along y, θ_{y}(f), is given by equation (2):

$${θ}_{y} ( f ) = {sin}^{- 1} ( \frac{c}{f {Λ}_{y}} \frac{m o {d}_{2 π} [ Δ ( {ϕ}_{y} ( f ) ]}{2 π} ) \qquad ( 2 )$$

In equation (2), Λ_{y} is the row-to-row pitch, Δϕ_{y}(f) is the differential phase between adjacent grating-waveguides (equal to the phase accumulated across the preceding grating-waveguide and additional connecting components), and mod_{2π}[x] denotes the wrapped phase evaluated on the interval (−π, π].

The frequency shift to steer the beam by one spot width may be found by taking the derivative of the differential phase Δϕ(f) with respect to frequency and calculating the frequency step Δf to create a 2π phase shift across the length of the aperture: Δfᵢ=2π(Λᵢ/Lᵢ)(∂Δϕᵢ/∂f)⁻¹. The frequency shifts which steer the beam by one spot width along x and y, respectively, are expressed in equation (3).

$$Δ {f}_{x} = 2 {π ( N \frac{\partial {Δϕ}_{x}}{\partial f} )}^{- 1} = \frac{c}{{n}_{g} ( f ) N {Λ}_{x}} \\ Δ {f}_{y} = 2 {π ( M \frac{\partial {Δϕ }_{y}}{\partial f} )}^{- 1} = \frac{Δ {f}_{x}}{M C} \qquad ( 30$$

In equation (3), n_{g} is the group index of the grating-waveguide mode, N is the number of periods along a single grating-waveguide, M is the number of grating-waveguide rows, and C is a constant that accounts for additional delay that may be incurred from row-to-row connecting components. It is clear from equations 3 and 4 that for a coarse frequency shift of Δfₓ, the beam is steered by one spot width in θₓ and by MC spot widths in θ_{y}, during which C is the number of times θ_{y} scans the y-dimension FOV.

In embodiments, a silicon-photonic serpentine optical phased array (SOPA) performs, without any active phase shifters, 2D beamsteering from a mm-scale folded grating by simple coarse and fine increments to the laser wavelength. Coarse wavelength beamsteering along the direction y of the row waveguide grating occurs just like in previous grating coupled optical phased arrays or diffraction from conventional spectroscopic gratings. The SOPA accumulates delay through a sequence of waveguide grating rows, using the low loss of the fundamental mode of multimode Si waveguides combined with low-loss tapers and bends, and flyback waveguides to the next row, thereby enabling fine wavelength-steered beam steering across the rows. In embodiments, more than 16,500 beams in a 610×27 array are addressed using a 1450-1650 nm wavelength sweep with each beam having 1.6 GHz of bandwidth available for LIDAR ranging. In embodiments, SOPA devices tiled into arrays have been designed with 128×64 wavelength steered resolvable spots by using more grating rows and should achieve increased bandwidth of 3 GHz per beam by using a more efficient serpentine time delay accumulation. More than 90% of the SOPA tile area is used for emission of a tailored-profile beam enabling efficient stacking of the SOPAs into a large tiled aperture array.

Embodiments herein pertain to a novel type of active LIDAR imaging aperture. Such embodiments employ a K×K array of wavelength-steered SOPA tiles 100 (an array of arrays) for high resolution beamforming and imaging with increased transmission power, detection range, and receive aperture sensitivity. In embodiments, such an array is operated by first cohering the phases emitted by each SOPA tile, and then linearly tilting the phases across the array to raster beam scan an K×K super-resolved spot within each wavelength steered beam. In embodiments, computational synthetic aperture imaging is performed using a sparse subarray from within the K×K array of beam-steering tiles that allow the “super-resolution” imaging of the target illuminated within a single wavelength steered beam without explicitly cohering the tiles by using a self-calibration procedure. Embodiments herein include a novel approach to 3D LIDAR imaging from a synthesized spatio-temporal aperture based on non-redundant arrays (NRA) transmitting a non-redundantly spaced set of frequency offsets that is compatible with phase calibration of the emitting tiles using only the return signals based on a modified form of Schwab's algorithm. (F. Schwab, “Adaptive calibration of radio interferometer,” in IOC, vol. SPIE 231, p. 18, 1980.)

### Analysis of 3D F-BASIS LIDAR Using NRAs of SOPA Tiles

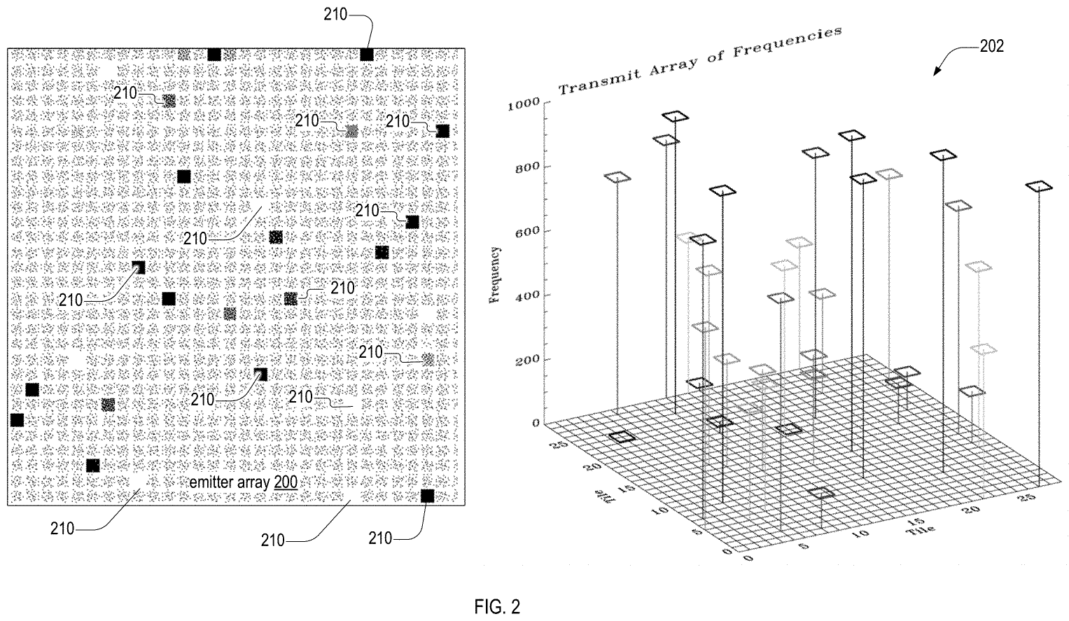

Our approach to 3D imaging may be used with any type of array imaging technology, including LIDAR optical phased arrays, radar active phased array antennas, or ultrasonic arrays of piezoelectric transducers. In this section we describe it in terms of our easily controlled SOPA beamsteering tiles 100. The spatial non-redundant array (NRA) comprises N transmitting tiles (each of size X×Y) out of a K×K array, and is represented by the position vectors \vec{r}ₙ such that all \vec{r}ₙ−\vec{r}ₘ are unique. The non-redundant frequencies fₙ (spanning the beamsteering bandwidth B and on a frequency grid of spacing Δf) are chosen such that all fₙ−fₘ are also unique. The key innovation of a non-redundant frequency encoded NRA is illustrated in FIG. 2.

FIG. 2 illustrates an example of a 30×30 2D emitter array 200 with N-element NRA of tiles 210 embedded therein. In this example, N=35. Plot 202 illustrates array 200 with respective frequencies emitted by each tile 210. SOPA beamsteering tiles 100 is an example of tile 210.

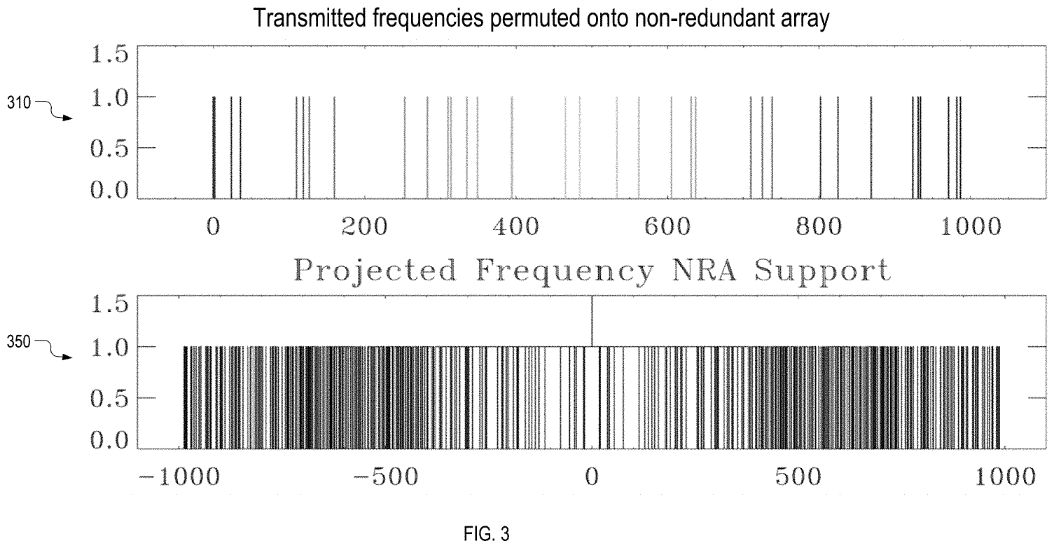

In embodiments, each tile 210 of emitter array 200 transmits a beam (electromagnetic or acoustic for example) that has a carrier frequency. The carrier frequency is a permuted selection from a 35-element Golomb ruler 310 of frequencies, shown in FIG. 3. FIG. 3 also includes a 1-D autocorrelation 350 of Golomb ruler 310. For clarity of illustration, not all tiles 210 are labeled with a reference numeral in FIG. 2. As a Golomb ruler, no two pairs of frequencies of ruler 310 are separated by the same frequency difference.

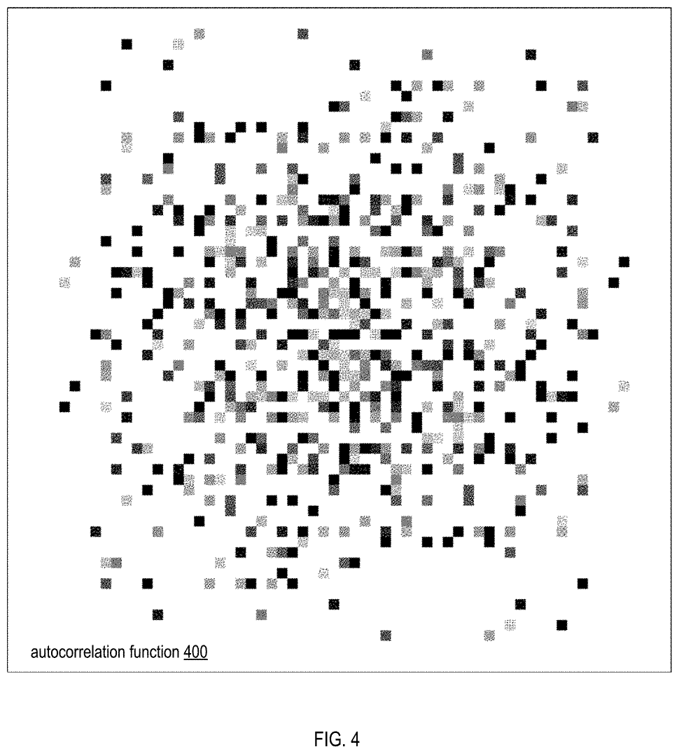

FIG. 4 is a plot of a 3D autocorrelation function 400, which is a set of 3D spatial frequencies sampled by emitter array 200 as determined by the temporal frequencies of each beam emitted by a tile 210. Gray-scale levels are used to represent the transmitted frequencies and detected beat note frequencies, which all must fit within the few GHz wide beamsteering bandwidth of the SOPA tile.

Transmitting a permuted set of frequency non-redundant shifted tones from the 2D spatial NRA of SOPA tiles may be represented as E(x′, y′, t) in equation (4).

$$E ( {x}^{′} , {y}^{′} , t ) = {\sum }_{n}^{N} δ ( \vec{r} - {\vec{r}}_{n} ) * [ Π [ \frac{{x}^{′}}{X} ] Π [ \frac{{y}^{′}}{Y} ] {e}^{- i 2 π {f}_{n} t} {e}^{i2 π ( α {x}^{′} + β {y}^{′} )} ] {e}^{- i {ω}_{o} t} + cc . \qquad ( 4 )$$

2D SOPA beamsteering gives

$$α = {n}_{eff} ( f ) - \frac{c}{f {Λ}_{x}} and β = \frac{c}{ω {Λ}_{y}} {mod}_{2 π} Δ {ϕ}_{y} ( ω ) ,$$

with ω=ωₒ+2πfₙ. The far field illumination is E(\vec{r}, t) as in equation (5).

$$E ( \vec{r} , t ) = {e}^{i ( {k}_{o} z - {ω}_{o} t )} / i {λ}_{Z} {e}^{{ik}_{0} ( {x}^{2} + {y}^{2} )} {/}^{2 z} XY sin c [ Xx - α z / λ z , Yy - β z / λ z ] \times {\sum }_{n}^{N} {e}^{i \frac{{ω}_{n}}{2 C Z} [ {( x - α z )}^{2} + {( y - β z )}^{2} ]} {e}^{- i \frac{2 π}{λ z} [ ( x - α z ) {x}_{n} + ( y - β z ) {y}_{n} ]} {e}^{- i {ω}_{n} ( t - \frac{z}{c} )} \qquad ( 5 )$$

Intensity I(\vec{r}, t) illuminating the far-field 3D target is simplified by letting x̅=x−αz and y̅=y−βz so that, as expressed below, equation (6).

$$I ( \vec{r} , t ) = \underbrace{\frac{{X}^{2} {Y}^{2} sin {c}^{2} [ X , \frac{\overline{x}}{λ z} , Y \frac{\overline{y}}{λ z} ]}{{λ}^{2} {z}^{2}}} {\sum }_{n , m}^{N} {e}^{i \frac{{ω}_{n} - {ω}_{m}}{2 c z} [ {\overline{x}}^{2} + {\overline{y}}^{2} ]} {e}^{i \frac{2 π}{λ z} [ \overline{x} ( {x}_{n} - {x}_{m} ) + \overline{y} ( {y}_{n} - {y}_{m} ) ]} {e}^{- i ( {ω}_{n} - {ω}_{m} ) ( t - z / c )} \approx P ( x , y , z ) {\sum }_{n , m > n} 2 cos [ 2 π ( {f}_{n} - {f}_{m} ) ( t - \frac{Z}{c} ) + \frac{π}{λ z} [ \overline{x} ( {x}_{n} - {x}_{m} ) + \overline{y} ( {y}_{n} - {y}_{m} ) ] ]$$

which represents a 3D traveling interferometric fringe, with P(x, y, z) represents a beam emitted to a specific angle by 2D wavelength controlled beamsteering to illuminate a particular 3D object.

For N transmitting tiles this represents a set of

$$\frac{N ( N - 1 )}{2}$$

3D tilted interferometric fringe patterns projected onto the target and propagating through it at velocity c. The transverse spatial frequencies are determined by the tile spatial separation

$$( {u}_{o}^{n m} , {v}_{o}^{n m} ) = \frac{1}{λ z} [ ( {x}_{n} - {x}_{m} ) , ( {y}_{n} - {y}_{m} ) ] .$$

The longitudinal spatial frequency (moving at speed c) is wₒ^{nm}=(fₙ−fₘ)/c. The 3D target reflectivity may be expanded in its Fourier components as r(x, y, z)=∫∫∫ [symbol] (u, v, w)e^{j2π(ux+vy+wz)}dudvdw.

The backscatter propagating back to the receiver at velocity−c from a target nominally at range z₀=cT (and within the unambiguous range window c/2δf) is collected and detected by a large integrating incoherent detector or by an array of receive SOPA tiles without suffering from any heterodyne speckle loss since each pair of beams backscattered by the rough object surface create identical overlapping speckle fields that beat against each other with full modulation depth. The mod square-law detected power, I(t), contains

$$\frac{N ( N - 1 )}{2}$$

temporal frequencies, fₒ^{nm}=wₒ^{nm}c, each encoding a unique object 3D Fourier component, as shown in equation (7) below.

$$\begin{matrix}I ( t ) = \int \int \int \int \int \int ℛ ( u , v , w ) {e}^{j 2 π ( u x + v y + w z )} dudvdw \\ \times {\sum }_{n , m} [ {e}^{j 2 π ( x {u}_{o}^{n m} + y {v}_{o}^{n m} + ( c t - z - {z}_{0} ) {w}_{o}^{n m}} + cc ] dxdydz * δ ( t + {z}^{′} / c ) {\vert}_{{z}^{′} = 0} \\ = {\sum }_{n , m} ℛ ( {u}_{o}^{n m} , {v}_{o}^{n m} , 2 {w}_{o}^{n m} ) {e}^{j 2 π {w}_{o}^{n m} c ( t - 2 T )}\end{matrix}$$

The temporal oscillations of the detected signal encode the magnitude and phase of the corresponding 3D Fourier components which are inserted into a 3D Fourier space.

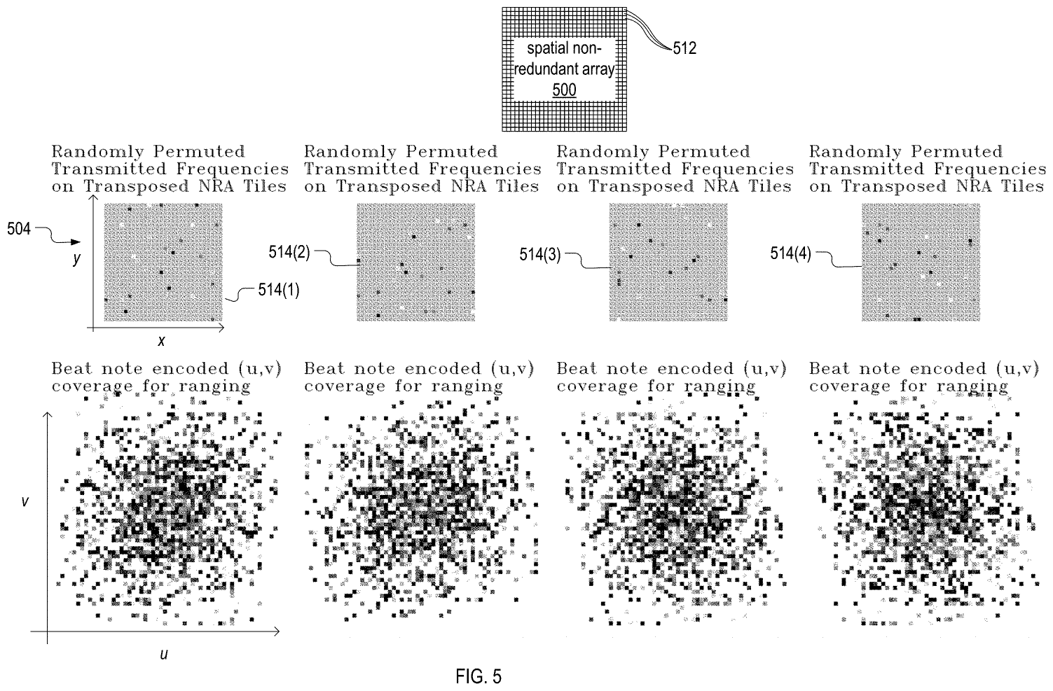

FIG. 5 illustrates a N=35-element spatial nonredundant array (NRA) 500 and the first four elements of a transmission-frame sequence 504 of permuted non-redundant frequency-encoded mutually coherent beam arrays 514, emitted from NRA 500, that are flipped and rotated. The first four elements are mutually coherent beam arrays 514(1-4). The representations of coherent beam arrays 514 are also referred to herein as “transmission frames.”

NRA 500 is an example of emitter array 200, FIG. 2 and includes a plurality of tiles 512, each of which is an example of tile 210. FIG. 5 also includes four heatmap plots 520(1-4) showing spatial frequency and temporal frequencies of beat notes (encoded as gray levels) resulting from interference of mutually coherent beams emitted from the NRA. In plots 520, values on horizontal axis and vertical axis are horizontal spatial frequency u and vertical spatial frequency v respectively.

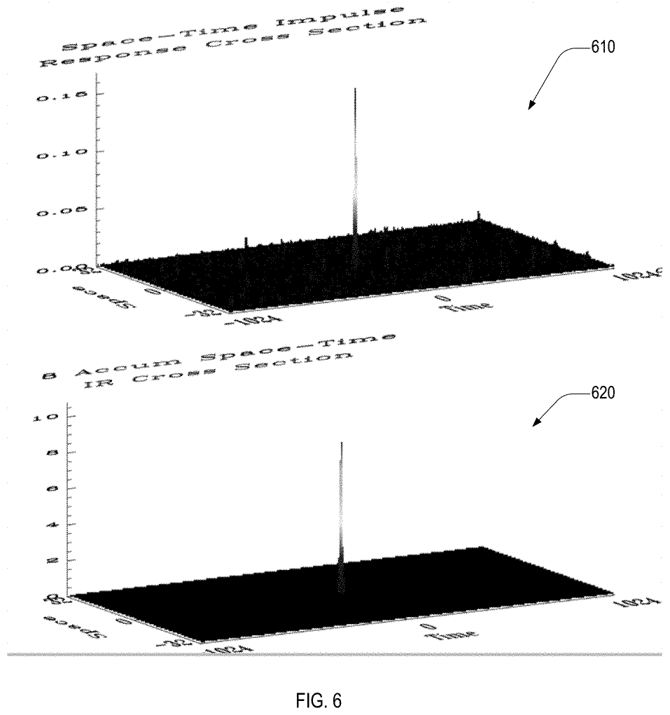

FIG. 6 illustrates a spatio-temporal impulse response cross-section 610 that has predominant noisy “grass” sidelobes that are substantially suppressed by accumulating just eight flipped and permuted transmission frames 514, as shown by spatio-temporal impulse response 620.

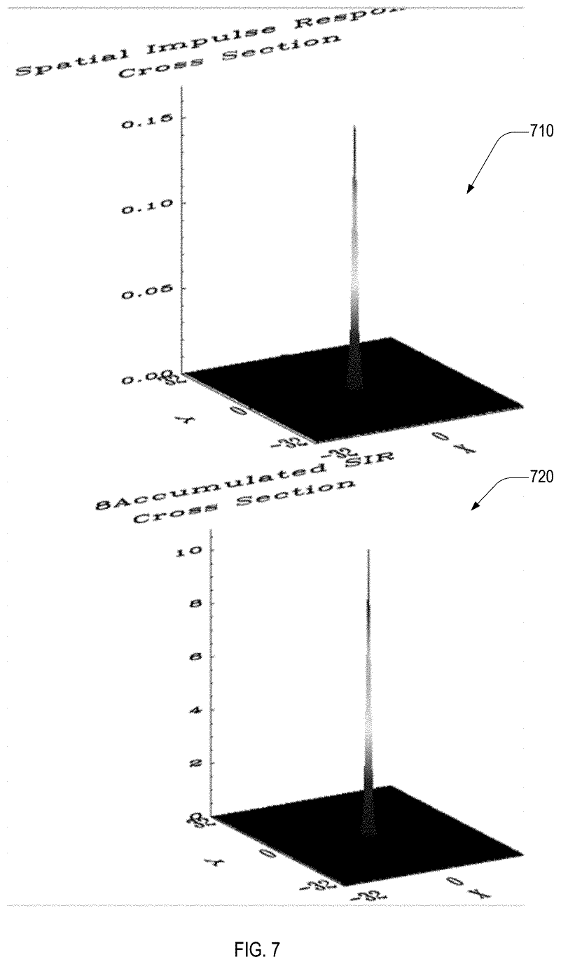

FIG. 7 illustrates a 2D spatial impulse response cross-section 710 that has predominant noisy “grass” sidelobes that are substantially suppressed by accumulating just eight flipped and permuted transmission frames 514, as shown by 2D spatial impulse response 720.

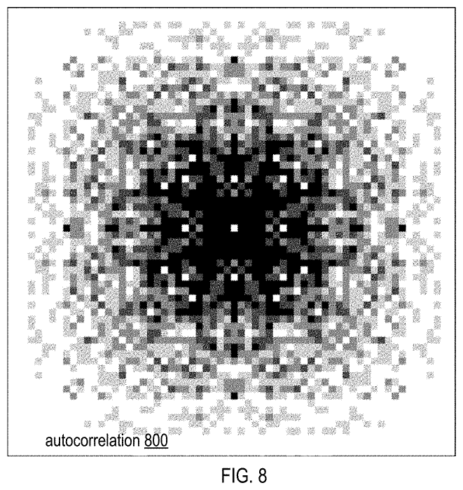

FIG. 8 is a heatmap of a spatial autocorrelation 800 of an average of transmission-frame sequence 504. Spatial autocorrelation 800 is the spatial OTF of a range-resolved imager that includes spatial non-redundant array 500. Each tile 512 of array 500 transmits a permuted selection from a 35-element Golomb ruler 310 of frequencies, shown in FIG. 3.

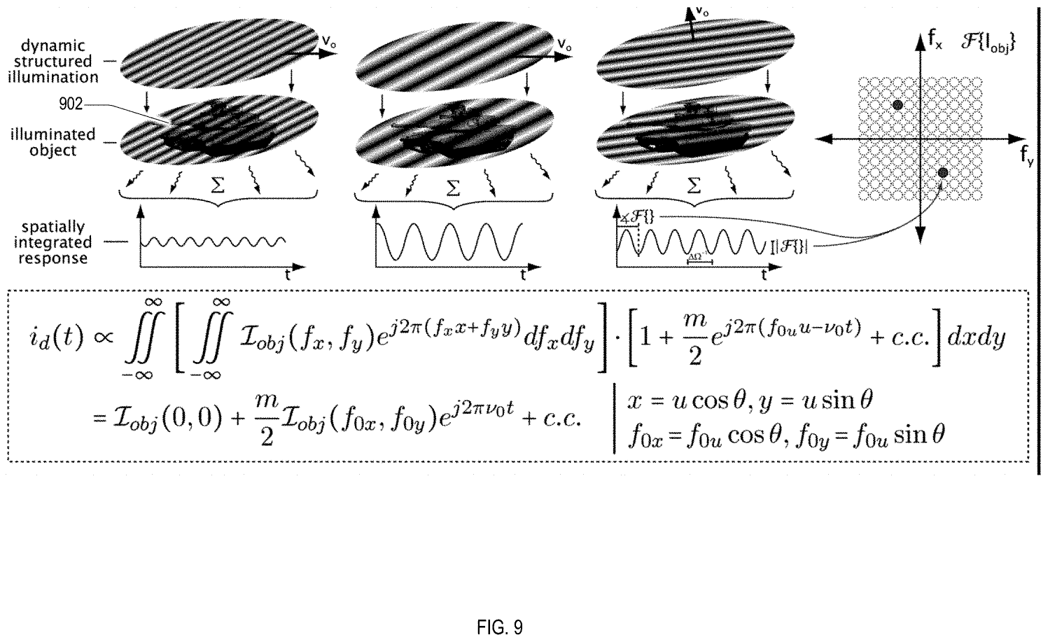

A structured illumination technique for 2-dimensional objects is illustrated in FIG. 9. This technique can be extended to near field 3D object sensing, for example in a microscope, in which the object could be illuminated from a plurality of angles, but previously was not capable of range resolving the pixels of far-field objects as presented here. This is the case even for a 3D object, such as the illustrated tank 902, primarily because the frequency offsets between the beams was too small to resolve the depth structure of the 3D object and because the frequency shifts were produced using crossed acousto-optic devices in which the frequency shift and spatial shift of the illuminating beams were proportional (by the acoustic velocity), which results in a planar sampling of 3D Fourier components incapable of producing 3D images. But the operation as a 2D imager (without range resolving capabilities) is very similar to the 3D imager presented here.

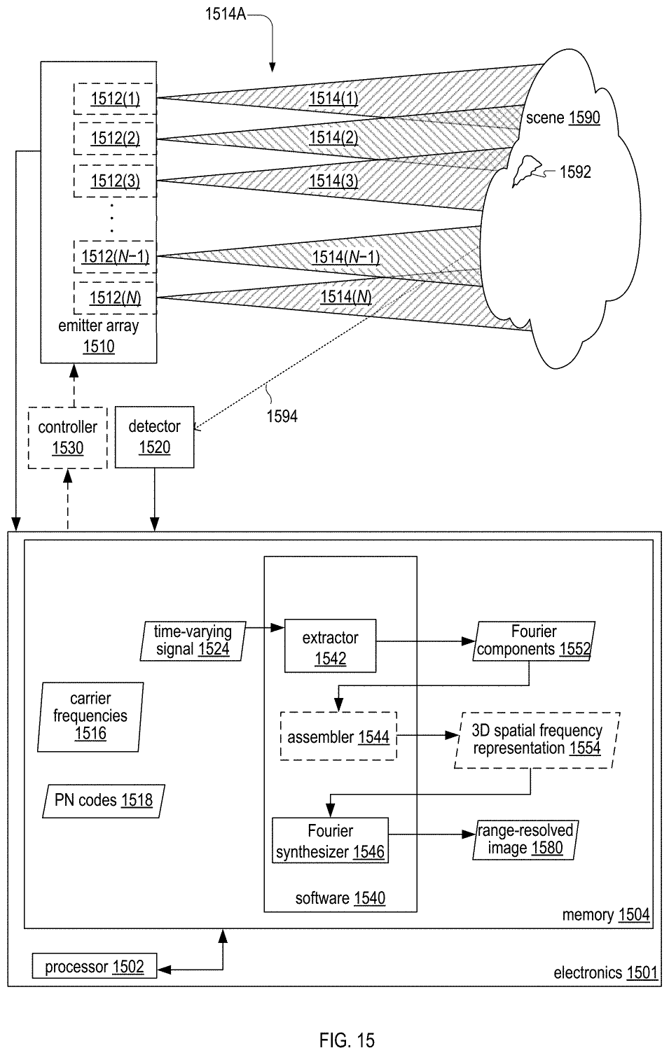

Frequency shifted beams are produced on a 2D grid by applying frequencies to a pair of crossed acoustooptic devices. These beams are examples of beams 1514, FIG. 15. This does require that the spot arrays are separable, but will be explained initially without this constraint. As illustrated, two spots are produced in the pupil plane of a transmitting telescope at coordinates (fⁱₓ/fⁱ_{y}) and (f^{j}ₓ/f^{j}_{y}) with frequency shifts off fᵢ=nᵢ [symbol] fₓ+mᵢ [symbol] f_{y} when generated using AODs) and fⱼ (=nⱼ [symbol] fₓ+mⱼ [symbol] f_{y}). When projected onto a far field object these beams will interfere to produce a sinusoidal fringe pattern that will paint itself across the spatial reflectivity of the object, r(x,y), producing a backscattered signal as the product of the illumination, i(x,y,t). Because of the frequency difference between these beams, the fringes will move at fᵢⱼ=fᵢ−fⱼ spatial fringes per second, which will correspond to a magnified version of the acoustic velocity along the x and y axis. If the object has a matched 2-dimensional spatial frequency component, then the integrated intensity detected back at the receiver on a spatially integrating detector will record large swings at the frequency fᵢⱼ, with a temporal amplitude and phase proportional to the corresponding 2-dimensional spatial Fourier component probed by that spatial interference fringe pattern with a spatial frequency along x proportional to u=(fⁱₓ/f^{j}ₓ)/λz, and along y given by v=(fⁱ_{y}−f^{j}_{y})/λz.

Different Fourier components can be probed sequentially as illustrated in the three panels of this figure by changing the spacing of the illuminating pairs of spots and their relative orientation in order to sample the necessary spatial frequency components of the object. In practice a non redundant array of frequencies is applied to each crossed acousto-optic device with slightly different frequency spacings to produce a cross-product non-redundant spatio-temporal array that allow for generating large non-redundant 2D spot arrays (40×40 have been demonstrated) that allows for the probing of many 2D spatial frequencies simultaneously and in parallel (N(N−1)/2 is more than a million in this case).

As shown in FIGS. 2-5, to improve the 3D point spread function, multiple frames with distinct spatial NRAs and randomly permuted frequencies are used to accumulate additional non-overlapping 3D Fourier components. After a handful of transmission frames (indexed by k, e.g., transmission frames 514(1, 2, . . . )) have been probed and the backscatter detected, Fourier transformed, complex demodulated at all the difference frequencies ωₙ−ωₘ, Fourier synthesis (or 3D FFT) sums up the 3D spatial frequencies within the beam to produce the 3D LIDAR image. Equation (8) below is an expression for object-reconstruction estimate \hat{r}(x, y, z).

$$\hat{r} ( x , y , z ) = \frac{( {z}^{2} P ( x , y , z ) > thresh )}{P ( x , y , z )} {\sum }_{k} {\sum }_{n , m} ℛ ( {u}_{k}^{n m} , {v}_{k}^{n m} , 2 {w}_{k}^{n m} ) {e}^{j 2 π ( {u}_{k}^{n m} x + {v}_{k}^{n m} y + 2 {w}_{k}^{n m} z )}$$

The numerator (z²P(x, y, z)>thresh) equals z²P(x, y, z) when z²P(x, y, z) exceeds a threshold quantity thresh, and equals zero otherwise.

This reconstruction of the object estimate f fits within the beam footprint of the wavelength steered beam of the SOPA tiles, z²P(x, y, z). The impulse response shown in FIGS. 6 and 7 is determined by FFT of the sparse 3D Fourier domain support (which is given by the sums of the 3D autocorrelation of the frequency encoded transmission apertures), and just a few frame averaged transmission arrays are sufficient to suppress the sidelobes.

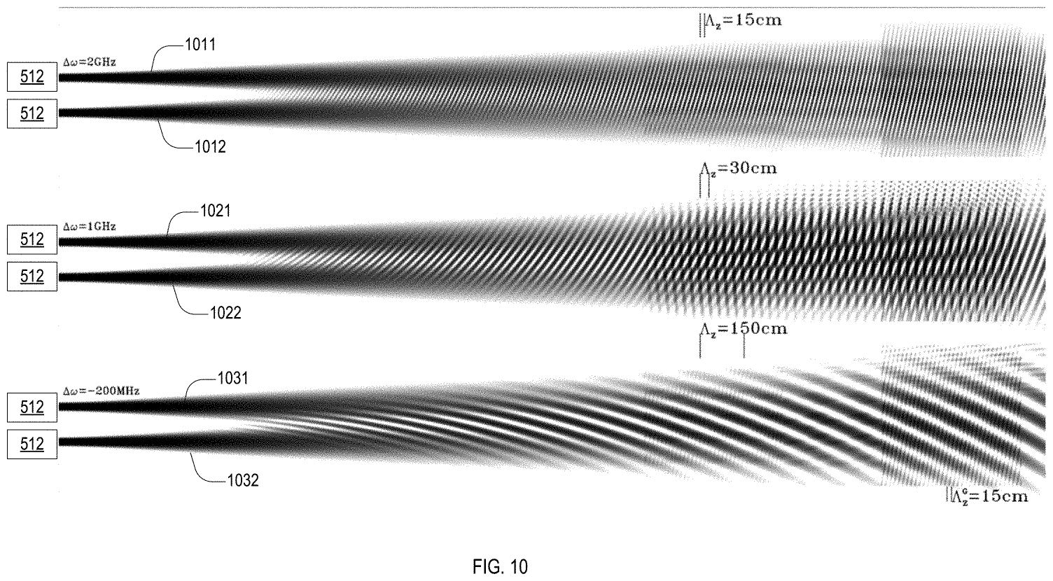

An illustration of the back scatter from a pair of frequency shifted tiles is shown in FIG. 10. Two tiles 512 are shown on the left side emitting Gaussian apodized beams 1011, 1012, 1021, 1022, and 1031 and 1032. Each of these beams expand as they propagate to the right, as they reach the far-field zone they overlap and interfere to produce traveling-wave sinusoidal fringes whose transverse spatial frequency, u, and spatial period, 1/u, depend only on the spatial separation of the two tiles, [symbol] x=xᵢ−xⱼ, operating wavelength, λ, and range, z, as u= [symbol] x/λz.

A 3D target containing a single Fourier component is illustrated on the right which in this 2D cross-section is just a square region containing a single sinusoidal frequency with a transverse period of 60 cm and longitudinal period of 15 cm. Three cases are illustrated, but all with the same spacing between the transmit tiles and at a range just starting to be in the far field with overlapping beams so that the interference between the two tiles produces a traveling wave intensity fringe pattern with transverse spatial frequency and corresponding period of 60 cm that is matched to the scattering object.

On the top is illustrated the case that the frequency shift between the two transmitting tiles is 2 GHz which gives a longitudinal periodicity of the spatial fringes of 15 cm, in the middle the frequency difference is 1 GHz which yields a fringe spacing of 30 cm, and on the bottom the frequency offset is 0.2 GHz which yields fringes with 150 cm of longitudinal period. These fringe patterns propagating away from the emitting apertures at the speed of light, c, backscatter off the target to produce a wave propagating back toward the detector adjacent to the transmitting aperture with a velocity−c, with an amplitude corresponding to the sampled Fourier component, which in this case is very small on the top and bottom, but quite large for the matched middle case in which a strong plane wave component is illustrated having propagated back part way towards the detector.

The matched case corresponds to an object fringe longitudinal periodicity of 15 cm and an interference fringe period of 30 cm that is twice the longitudinal period of the matched Fourier component due to the counter-propagation of the back-scattered beam. Notice in this case that the interference fringes appear slightly curved since the waves have not fully propagated into the far-field simply due to a limitation of this illustrative simulation, and in a real application scenario the interference fringes would be much closer to true planar fringes.

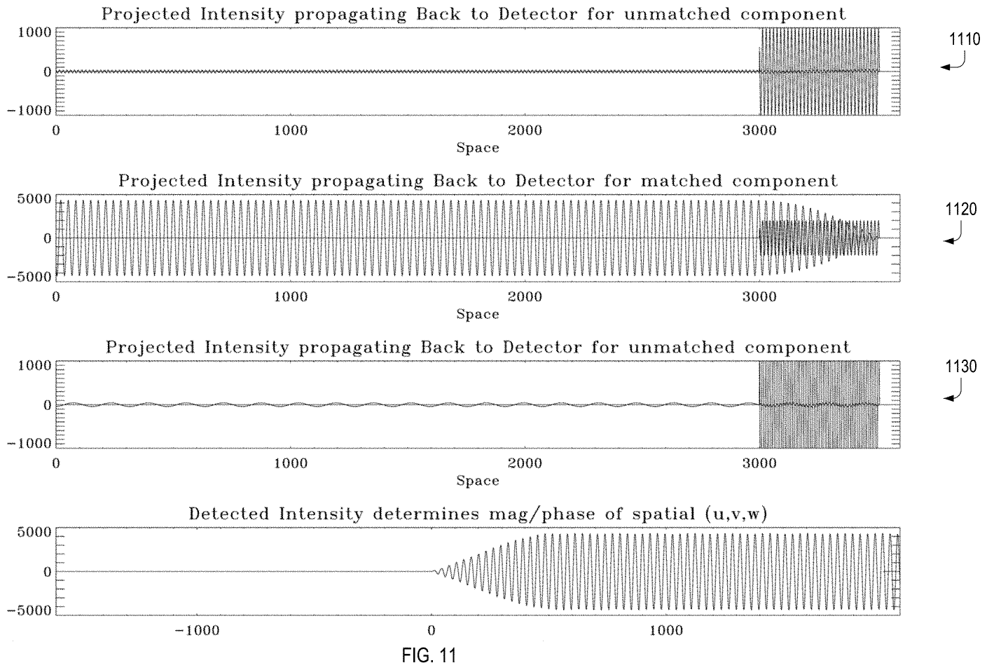

FIG. 11 is a one-dimensional cross-section of the illustrate scenario of FIG. 10 at a later time after the back-scattered wave has propagated back to the detector and generated a temporally oscillating signal. The top three plots correspond to a snapshot of respective back-scattered waves 1110, 1120, and 1130 as a function of space for the three cases illustrated previously, with the longitudinal periodicity of the scattering object shown on the right.

In the top and third plots where the interference fringe longitudinal period of the traveling wave launched by the transmitters is not matched to twice the longitudinal period of the object, then only a very weak back scattered wave is produced propagating back to the detector. But in the second plot where the longitudinal periods are appropriately matched, a back scattered wave can be seen building up throughout the volume of the object and then continuing to propagate as an intensity modulation back to the detector. This back-scattered intensity can be considered as being due to the individual scattering of the field from each transmitter which interfere back at the detector (and are illustrated here without the DC component of their interference). After the back-scattered wave reaches the detector, it begins to detect a temporally oscillating signal, illustrated in the bottom plot, whose temporal amplitude and phase encode the matched object's 3D Fourier component amplitude and phase encoded on a temporal frequency equal to the difference frequency of the two transmitted waves (in this illustrated case, 1 GHz).

The non-redundant set of frequencies transmitted from the spatial non-redundant array of emitters is selected such that the difference frequency between every pair of distinct frequencies is unique. This allows all of the probed 3D spatial Fourier components to be measured simultaneously on unique temporal beat notes at the difference frequencies which also probe the longitudinal components of the 3-dimensional spatial frequencies of the object. These temporal frequency components may be isolated and separated from each other with a demodulated amplitude and phase with a simple Fourier transform of the detected signal across a time window a few times longer than the inverse frequency spacing between the most closely spaced frequencies, Δf. All of the transmitted frequencies are located at integer multiples of this frequency spacing, and the minimal length of the frequency grid needed to represent a certain number of frequencies can be searched for numerically, and the resulting set of N non-redundantly spaced objects is known as a Golomb ruler.

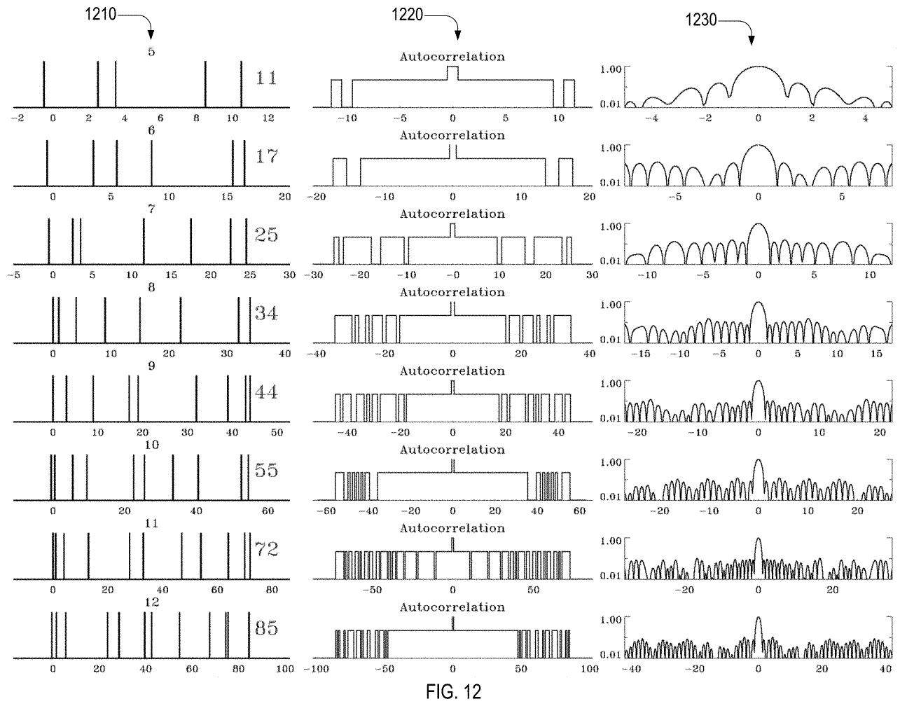

Golomb rulers 1210 with between five and twelve frequencies are illustrated in the left column of FIG. 12, and the non-redundancy of these sets is verified by looking at the corresponding autocorrelations 1220 in the center column, which except at 0, only takes on the values of 0 and 1. One of the optimally short Golomb ruler with N=5 tones has frequency offsets [0, 3, 4, 9, 11] and so spans a bandwidth N=11 times the minimum increment, Δf, while a Golomb ruler with ten tones has frequency offsets [0, 1, 6, 10, 23, 26, 34, 41, 53, 55], and hence spans a bandwidth 55 [symbol] f.

For N=20, tones the optimal Golomb ruler are [0, 24, 30, 43, 55, 71, 75, 89, 104, 125, 127, 162, 167, 189, 206, 215, 272, 275, 282, 283] which for Δf=1 MHz would span a bandwidth of 283 MHz and the transmit frequency offsets for each of the transmitting tiles would be shifted by the indicated number of MHz in this twenty-element array. The frequencies may be arbitrarily permuted when assigned to the spatial non-redundant array elements. Optimal Golomb rulers are known up to N=27, and close to optimal non-redundantly spaced sets may be found numerically up to large values of N (as large as N=65,000) with a bound on the length of the array on the order of O(N²).

The Fourier transform of the autocorrelation of the frequencies in the Golomb ruler or other non-redundant set of frequencies (with the zero-lag term suppressed) provides for an estimate of the ranging impulse response of this 3-dimensional imager, and these are shown in the right column of the FIG. 12, as ranging impulse-responses 1230. When Δf is kept constant as more frequencies (and corresponding spatial NRA elements) are added, the bandwidth expands and the ranging resolution of the central peak reduces in proportion to the total bandwidth which scales approximates as B=O(N²)Δf, and corresponding range resolution of ΔR=c/2B. Hence, the range resolution may be increased to the point that the array elements no longer operate properly, or in the case of the SOPA tiles until the wavelength beam-steered array steers off the desired main beam direction so that the far field spots will no longer properly overlap, which is typically a few GHz bandwidth, allowing for range resolution as fine as 5-10 cm.

However, note that in this scheme, each element in the NRA only transmits a bandwidth on the order of a fraction of [symbol] f in order to turn on or off the beams at a time interval of a few times 1/ [symbol] f as required to adequately resolve each difference frequency component of the detected signal. This would allow highly resonant and high efficiency transmitters for RF and acoustic implementations.

The rather large sidelobes of the Fourier transform of the autocorrelation in the right column do not decrease substantially as more non-redundant elements of the Golomb ruler or other non-redundant frequency set are added, but the specific placement of the sidelobes is different for different non-redundant sets of frequencies.

This suggests averaging over a few different sets of non-redundant frequencies may serve to enhance the main lobe while suppressing the sidelobes, and this is even more effective for the case of 3-dimensional spatio-temporal non-redundant arrays where permuted or rotated spatial NRAs are addressed by different non-redundant sets of frequencies. So, although there may only be 1 or 2 optimal Golomb rulers there are a huge number of slightly larger non-redundant sets that may be used, and for N>27 the optimal Golomb rulers are not yet known, so the use of suboptimal non-redundant sets of frequencies found numerically are perfectly adequate, since the length of the suboptimal sets are only slightly longer.

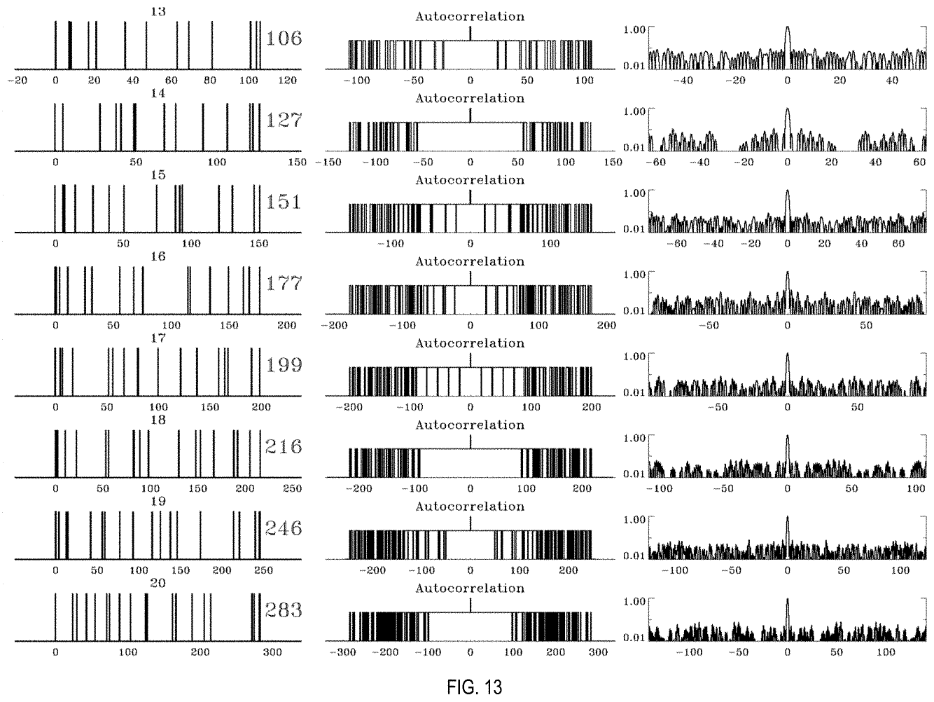

In FIG. 13 are shown the Golomb rulers, their autocorrelations, and corresponding ranging impulse responses for the number of transmit tones, N, varying from 13 to 20 and lengths of the grids into which they are embedded varying from 106 to 283.

For the nonredundant set of frequencies of the Golomb ruler (or other non-optimal non-redundant set) selected off a grid of spacing [symbol] f=1 MHz, all the N transmit tones will have a period which is an integer fraction of T=1/ [symbol] f=1 μsec. Synchronizing the phases of all of the offset frequencies at time t=0, will lead to their realignment at 0 phase of all the tones each microsecond after that. This may be manifest by coherently summing all N of the transmit tones from all of the tiles, and this may be experimentally performed by placing a small retro-reflector point target in the far field to direct an equal amplitude portion of all the transmitted fields back to the detector for coherent heterodyne detection with a reference or more simply with an incoherent detection of all the beat notes between the transmitted frequencies as used in the 3-dimensional object imaging operation.

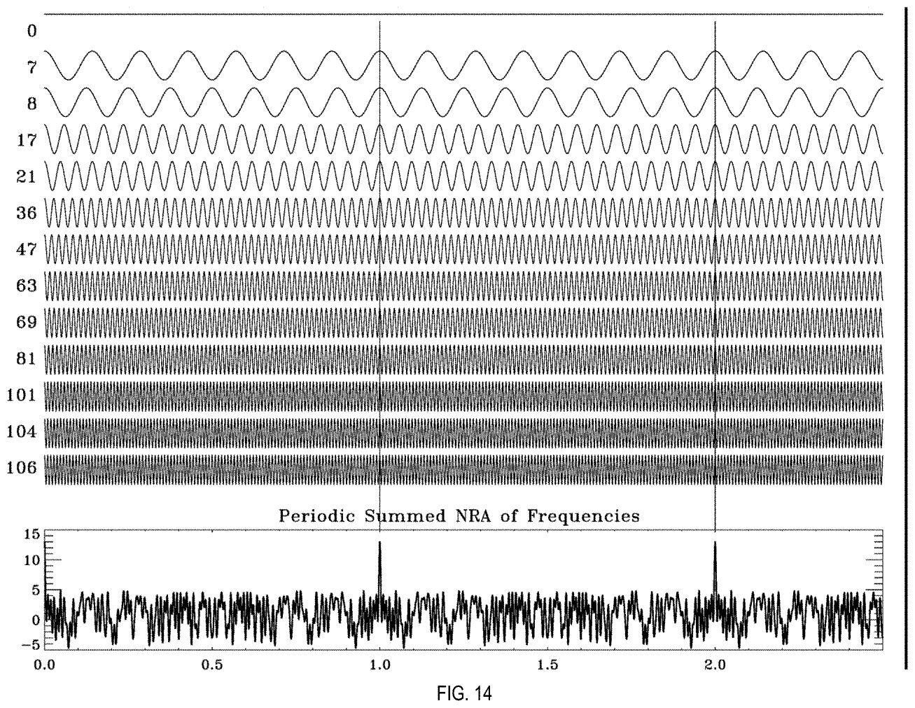

For the case of a target a distance z_{c} away from the planar emitting aperture this will lead to a return waveform with peaks at times t_{c}=2z_{c}/c+kT for integers, k. This periodically rephased detected peak is illustrated in FIG. 14 for the case N=13 which corresponds to transmitted tones shifted by [0, 7, 8, 17, 21, 36, 47, 63, 69, 81, 101, 104, 106] MHz from the nominal carrier frequency and these oscillations are illustrated in the rows of this plot, the top row is constant, the next row is 7 MHz, followed by 8 MHz, etc., all the way up to 106 MHz in the bottom row. Similarly, the incoherently detected beat notes between all pairs of transmitted frequencies will be at integer frequencies spaced by 1 MHz intervals, with gaps as per the autocorrelation function of this 13 element Golomb ruler, spanning this 106 MHz range.

Summing up all the backscatter of the transmit tones from a point target coherently with a heterodyne reference will allow a cohering and calibration of the transmitted phases of the emitting tiles when the peak occurs at a shifted time from the expected time t_{c}=2z_{c}/c. In operation as a range-resolving imager, all of the backscattered fields will interfere pairwise generating beat notes on the same frequency grid of spacing [symbol] f, and summing all the frequency difference tones incoherently on a detector will also yield a periodic re-phasing of the detected peak each time T=1/Δf=1 μsec corresponding to an unambiguous range interval ΔR=c/2Δf=1 MHz=150 m for this example frequency grid minimal spacing Δf. Targets within this range interval cannot be differentiated from targets at a range r₁=z+ΔR or r₂=z+2ΔR or rₚ=z+pΔR for integer p, except for the fact that farther targets are inevitably weaker due to the unavoidable 1/r² scaling of the backscattered signal amplitude with range r. Thus, when a particular operating range window is required, then the frequency grid spacing may be chosen appropriately, for example when an unambiguous range window of 1.5 km is required, the frequency spacing may be chosen as [symbol] f=0.1 MHz.

FIG. 15 is a schematic block diagram of a range-resolved imager 1500, hereinafter imager 1500. Imager 1500 includes an emitter array 1510, a detector 1520, a processor 1502, and a memory 1504. Processor 1502 and memory 1504 are shown as part of electronics 1501, which may include only processor 1502 and memory 1504, or may include additional hardware components. Emitter array 200 is an example of emitter array 1510. Emitter array 1510 includes a plurality of emitters 1512, of which tiles 512 are examples.

In operation, emitter array 1510 illuminates a scene 1590 with a plurality of mutually coherent beams 1514. Examines of beams 1514 includes Gaussian apodized beams 1011, 1012, 1021, 1022, and 1031 and 1032, FIG. 10. Beams 1514 form a beam array 1514A, examples of which is beam arrays 514, FIG. 5. Detector 1520 detects a backscattered signal 1594, scattered by an object 1592 in the scene 1590, that propagates toward the detector 1520.

Memory 1504 stores machine readable instructions, stored as software 1540, that when executed by processor 1502, control processor 1502 to execute range-resolved imaging methods disclosed herein. Each of back-scattered waves 1110, 1120, and 1130, FIG. 11, is an example of time-varying signal 1594. During a process of generating a range resolved-image 1580, stored in memory 1504, from signals received from detector 1520, memory 1504 also stores Fourier components 1552. Software 1540 includes an extractor 1542, a Fourier synthesizer 1546, and, in embodiments, an assembler 1544.

In embodiments, emitter array 1510 is one of a sparse array and a minimally-redundant array. In embodiments, emitters 1512 are at least three in number and form a non-redundant array. Each pair of emitters 1512 of the non-redundant array are separated by a respective distance that differs from a respective distance between each other pair of emitters of the non-redundant array.

In embodiments, emitter array 1510 includes at least one of (i) a spatial non-redundant group of emitters, (ii) a sparse group of emitters, and (iii) including a plurality of emitters, each pair of emitters thereof producing a pair of mutually coherent beams having a distinct frequency difference from every other pair of emitters in the group of emitters.

In embodiments, each emitter 1512 is being one of: a tile of serpentine optical phased array (SOPA) 2D wavelength beamsteering tiles with grating couplers on successive rows, an optical phased array, a microelectromechanical system (MEMS), a spatial light modulator (SLM), a deformable micromirror device (DMD), a telescope, an optical fiber, a photonic integrated circuit (PIC) with one of an edge-coupler and a grating-coupler, an acoustic transducer, optical emitter of mutually coherent light, a radiofrequency emitter, a microwave emitter, and an acoustic emitter.

In embodiments, detector 1520 is one of (i) an integrating incoherent receiver, (ii) an array of current summed serpentine optical phased array (SOPA) receiver tiles incorporating wideband waveguide detectors in each tile, and (iii) a wideband summed output of a detector array.

Memory 1504 may store carrier frequencies 1516 and pseudorandom noise codes 1518. Example of carrier frequencies 1516 include frequencies of Golomb ruler 310 and 910, or any plurality of non-redundantly spaced frequencies.

In embodiments, imager 1500 includes a controller 1530 communicatively coupled to both emitter array 1510 and electronics 1501. Controller 1530 may include a modulator, and may be part of electronics 1501. In embodiments, controller 1530 drives each emitter 1512 to emit a respective beam 1514 with a particular carrier frequency 1516 modulated with a specific pseudorandom noise code 1518.

In embodiments, coherent beams 1514 are N in number and each beam 1514 has a respective one of N distinct carrier frequencies f₁, f₂, . . . , f_{N} that are non-redundant, such that each frequency difference (fᵢ−fⱼ) between any two of N(N−1)/2 pairs of carrier frequencies is unique, wherein each of indices i and j is less than or equal to N and i≠j. The N distinct carrier frequencies f₁, f₂, . . . , f_{N} may be selected from a regular grid of frequencies spaced by [symbol] f. Such a grid of frequencies containing N non-redundantly spaced frequencies will span a bandwidth of at least N²Δf, will require an observation time of several times T=1/ [symbol] f to resolve each beat note, and will enable operation over an unambiguous range interval of ΔR=(c/2)/ [symbol] f.

Memory 1504 may be transitory and/or non-transitory and may include one or both of volatile memory (e.g., SRAM, DRAM, computational RAM, other volatile memory, or any combination thereof) and non-volatile memory (e.g., FLASH, ROM, magnetic media, optical media, other non-volatile memory, or any combination thereof). Part or all of memory 1504 may be integrated into processor 1502.

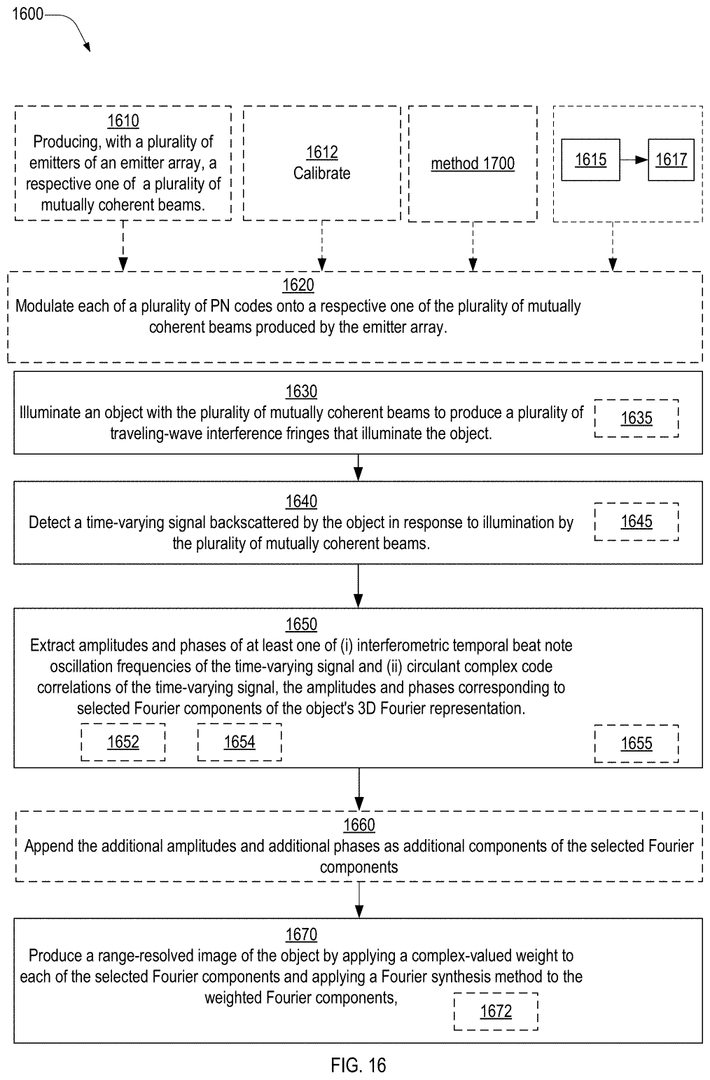

FIG. 16 is a flowchart illustrating a range-resolved imaging method 1600. Method 1600 may be implemented within one or more aspects of range-resolved imager 1500. In embodiments, method 1600 is implemented by processor 1502 executing computer-readable instructions of software 1540. Method 1600 includes steps 1630, 1640, 1650, and 1670.

Step 1630 includes illuminating an object with a plurality of mutually coherent beams produced by an emitter array to produce a plurality of traveling-wave interference fringes that illuminate the object. Each of the plurality of mutually coherent beams being at least one of (a) shifted in frequency within a collective bandwidth of the emitter array, (b) encoded with a maximal length pseudorandom (PN) code time-shifted by a respective one of a plurality of time-shifts (c) encoded with a respective one of a plurality of codes, wherein a product of any two of the plurality of codes is a distinct code. In an example of step 1630, emitter array 1510 illuminates object 1592 with mutually coherent beams 1514.

In embodiments, step 1630 includes emitting each of the plurality of mutually coherent beams from a respective one of the plurality of emitters such that, at the object, each beam of the plurality of mutually coherent beams at least partially overlaps with another beam of the plurality of mutually coherent beams, thereby producing interferometric intensity fringes propagating away from the emitter array.

In embodiments, the selected Fourier components being N(N−1) in number, the plurality of mutually coherent beams being N in number, the plurality of traveling-wave interference fringes being N (N−1)/2 in number. In such embodiments, the illumination of step 1630 includes illuminating the object with the N mutually coherent beams simultaneously, thereby measuring the N(N−1) Fourier components in parallel. In embodiments, Fourier components 1552 includes a total of N(N−1) Fourier components.

In embodiments, method 1600 includes step 1610. Step 1610 includes producing the plurality of mutually coherent beams such that each pair of emitters of the emitter array produces a pair of mutually coherent beams, of the plurality of mutually coherent beams, having a distinct frequency difference from every other pair of mutually coherent beams of the plurality of mutually coherent beams. As a result of step 1610, each pair of mutually coherent beams produced by the group of emitters has a distinct frequency difference from every other pair of mutually coherent beams produced by the group of emitters. In such embodiments, the emitter array may include at least one of a spatial non-redundant group of emitters and a sparse group of emitters.

In embodiments, method 1600 includes step 1620, which includes modulating each of the PN-codes onto a respective one of the plurality of coherent beams respectively via a binary-phase-shift-key (BPSK) scheme. In an example of step 1620, controller 1530 modulates each of PN code 1518 onto a respective beam 1514.

In embodiments, method 1600 includes step 1612, which includes phase-calibrating a pair of the plurality of mutually coherent beams by establishing, at an instant in time, a specific phase offset between the pair of the plurality of mutually coherent beams. A benefit of 1612 is to enhance resolution of the range-resolved image, e.g., image 1580, produced by method 1600. Step 1612 may be part of either of steps 1610 or 1620, or may be executed independently from either step.

Step 1640 includes detecting a time-varying signal backscattered by the object in response to illumination by the plurality of mutually coherent beams. In an example of step 1670, detector 1520 detects time-varying signal 1594, which may be stored in memory 1504 as a time-varying signal 1524. In embodiments, the time-varying signal is a single time-varying signal.

Step 1650 includes extracting amplitudes and phases of at least one of (i) interferometric temporal beat note oscillation frequencies of the time-varying signal and (ii) circulant complex code correlations of the time-varying signal, the amplitudes and phases corresponding to selected Fourier components of the object's 3D Fourier representation. In embodiments, extractor 1542 of software 1540 extracts Fourier components 1552 from time-varying signal 1524.

In embodiments, each of the plurality of codes being a respective time-shifted copy of a maximal-length pseudorandom noise (PN) code. In such embodiments, the amplitude and phase extraction of step 1650 may include extracting amplitudes and phases of the circulant complex code correlations of the time-varying signal via PN code correlation and a rearrangement of the correlation peaks based on the shift-and-add property.

When a sequence satisfies the shift-and-add property, the bitwise modulo-2 addition of the sequence (with shift q₁) with a shifted copy of the same sequence (with shift q₂) produces a shifted version of the same sequence, aₘ₋ᵣ=a_{m-q}_{₁} ⊕a_{m-q}_{₂}, where ⊕ represents modulo-2 addition (XOR) between the bits of the shifted sequences.

In embodiments, each of the plurality of codes being different binary phase-shift keyed (BPSK) encoded PN codes, and the time-varying signal includes Gold codes. In such embodiments, the amplitude and phase extraction of step 1650 may include uses a bank of Gold code correlators.

In embodiments, step 1650 includes step 1652. Step 1652 includes extracting, with a temporal Fourier transform, amplitudes and phases of the interferometric temporal beat note oscillation frequencies.

Step 1670 includes producing a range-resolved image of the object by applying a complex-valued weight to each of the selected Fourier components and applying a Fourier synthesis method to the weighted Fourier components. The range-resolved image having a depth resolution substantially determined by the collective bandwidth and a transverse resolution substantially determined by a maximum spatial separation between any two of a plurality of emitters of the emitter array. In an example of step 1560, Fourier synthesizer 1546 produces a ranged-resolved image 1580 by applying a complex-valued weight to Fourier components 1552 and applying a Fourier synthesis method to the weighted Fourier components.

In embodiments, step 1670 includes step 1672. Step 1672 includes processing the selected Fourier components at least in part via a complex coefficient retrieval method that utilizes known (e.g., predetermined) or estimated features of at least one of the object and its Fourier transform. In embodiments, step 1672 includes calibrating at least one of the amplitudes and phases of the plurality of mutually coherent beams using a complex coefficient retrieval method. Technical benefits of step 1672 include at least one of (i) estimating the object's Fourier transform outside of the selected Fourier components, (ii) improving the measurement accuracy of the selected Fourier components, and (iii) iteratively improving the range-resolved image.

In embodiments, the selected Fourier components are N(N−1) in number, the plurality of mutually coherent beams being N in number, and the plurality of traveling-wave interference fringes being N (N−1)/2 in number. In such embodiments, method 1600 may include steps 1635, 1645, 1655, 1660. Steps 1635, 1645, and 1655, are parts of steps 1630, 1640, and 1650, respectively.

Step 1635 includes illuminating the object with an additional plurality of mutually coherent beams, which is one of (a) a permutation of the plurality of mutually coherent beams and (b) a second plurality of mutually coherent beams. In embodiments, mutually coherent beams 1514 include the additional plurality of mutually coherent beams of step 1635.

Step 1645 includes detecting an additional time-varying signal, scattered by the object in response to illumination by the additional plurality of mutually coherent beams, and including additional interferometric products of multiple pairs of the additional plurality of coherent beams. In embodiments, time-varying signal 1524 includes the additional time-varying signal of step 1645.

Step 1655 includes extracting additional amplitudes and additional phases of temporal oscillations of the additional time-varying signal. Step 1660 includes appending the additional amplitudes and additional phases as additional components of the selected Fourier components such that the 3D Fourier representation includes as many as 2N(N−1) Fourier components. In embodiments, Fourier components 1552 includes the additional amplitudes and additional phases of step 1655.

In embodiments, the 3D Fourier representation has dimensions Nₓ×N_{y}×N_{z}. In such embodiments, method 1600 include repeating steps 1635, 1645, and 1655 a total number of times equal to an integer Q. As such, the resulting 3D Fourier representation includes as many as QN(N−1) distinct complex non-zero 3D Fourier components scattered throughout the Nₓ×N_{y}×N_{z} 3D Fourier representation, since some of the sparse samples may overlap.

In embodiments, the second plurality of mutually coherent beams (of step 1635) is one of (i) a rotated version of the plurality of mutually coherent beams, (ii) a flipped version of the plurality of mutually coherent beams, and (iii) a different 2D non-redundant array (NRA) embedded within the Nₓ×N_{y} array of emitters with all the emitters addressed by a permuted version of the set of non-redundantly spaced frequencies or a different set of non-redundantly spaced frequencies.

When method 1600 includes step 1635, method 1600 may include steps 1615 and 1617. Step 1615 includes producing the plurality of mutually coherent beams with the emitter array, the emitter array being addressed by a set of non-redundantly spaced frequencies. Carrier frequencies 1516 are collectively an example of a set of non-redundantly spaced frequencies.

Step 1617 includes producing the second plurality of mutually coherent beams with the emitter array, the emitter array being addressed by either a permuted version of the set of non-redundantly spaced frequencies or a distinct and different set of non-redundantly spaced frequencies. In embodiments, emitter array 1510 produces the second plurality of mutually coherent beams as part of beam array 1514A.

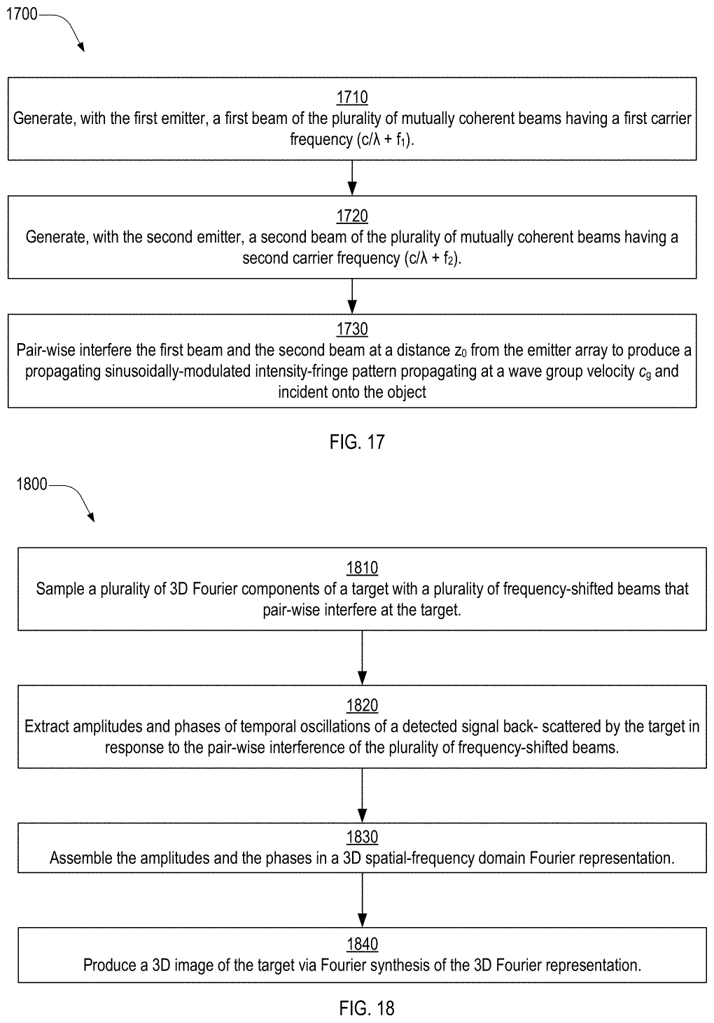

In embodiments, the emitter array including a first emitter and a second emitter displaced from the first emitter by Δx in a first direction and Δy in a second direction perpendicular thereto. At least one of Δx and Δy is non-zero. In such embodiments, method 1600 may include method 1700 for generating two beams of the plurality of mutually coherent beams and pair-wise interfering them. FIG. 17 is a flowchart illustrating method 1700. Method 1700 includes steps 1710, 1720, and 1730.

Step 1710 includes generating, with the first emitter, a first beam of the plurality of mutually coherent beams having a first carrier frequency (c/λ+f₁), where c is the speed of light and λ is a reference wavelength. In an example of step 1710, emitter 1512(1) generates the first beam as beam 1514(1). In embodiments, f₁<<c/λ. For example, c/λ>2×10¹⁴ Hz and f₁<2×10⁹ Hz.

Step 1720 includes generating, with the second emitter, a second beam of the plurality of mutually coherent beams having a second carrier frequency (c/λ+f₂). In an example of step 1710, emitter 1512(2) generates the second beam as beam 1514(2). In embodiments, f₂<<c/λ, e.g. f₂<2×10⁹ Hz.

Step 1730 includes pair-wise interfering the first beam and the second beam at a distance z₀ from the emitter array to produce a propagating sinusoidally-modulated intensity-fringe pattern propagating at a wave group velocity c_{g} and incident onto the object. As a result of step 1730, the selected Fourier components include 3D Fourier components (u, v, w) of the object having transverse components u=Δx/λzₒ, v=Δy/Δzₒ, and a longitudinal component ω=(f₁−f₂)/(c_{g}/2).

FIG. 18 is a flowchart illustrating a range-resolved imaging method 1800. Method 1800 may be implemented within one or more aspects of range-resolved imager 1500. In embodiments, method 1800 is implemented by processor 1502 executing computer-readable instructions of software 1540. Method 1600 includes steps 1810, 1820, 1830, and 1840.

Step 1810 includes sampling a plurality of 3D Fourier components of a target with a plurality of frequency-shifted beams that pair-wise interfere at the target. Each of the plurality of frequency-shifted beams has been emitted by a respective transmitter of a sparse transmitter-array. In an example of step 1810, range-resolved imager 1500 samples 3D Fourier components of object 1592 with beams 1514, which pairwise interfere at object 1592.

Step 1820 includes extracting amplitudes and phases of temporal oscillations of a detected signal back-scattered by the target in response to the pair-wise interference of the plurality of frequency-shifted beams. The amplitudes and phases correspond to selected 3D Fourier components of a plurality of temporal Fourier components of the detected signal. In an example of step 1820, extractor 1542 extracts amplitudes and phases of temporal oscillations of time-varying signal 1524 as Fourier components 1552.

Step 1830 includes assembling the amplitudes and the phases in a 3D spatial-frequency representation. In an example of step 1830, assembler 1544 assembles assembling the amplitudes and the phases of Fourier components 1552 to produce 3D spatial frequency domain representation 1554.

Step 1840 includes producing a range-resolved image of the target via Fourier synthesis of the 3D spatial-frequency representation. In an example of step 1840, Fourier synthesizer 1546 produces ranges-resolved image 1580 via Fourier synthesis of the 3D spatial-frequency representation 1554.

Changes may be made in the above three-dimensional imaging and systems without departing from the scope of the present embodiments. It should thus be noted that the matter contained in the above description or shown in the accompanying drawings should be interpreted as illustrative and not in a limiting sense. Herein, and unless otherwise indicated the phrase “in embodiments” is equivalent to the phrase “in certain embodiments,” and does not refer to all embodiments. The following claims are intended to cover all generic and specific features described herein, as well as all statements of the scope of the present three-dimensional imaging method and system, which, as a matter of language, might be said to fall therebetween.

What is claimed is:

1. A range-resolved imaging method comprising:
illuminating an object with a plurality of mutually coherent beams produced by an emitter array to produce a plurality of traveling-wave interference fringes that illuminate the object, each of the plurality of mutually coherent beams being at least one of (a) shifted in frequency within a collective bandwidth of the emitter array, (b) encoded with a maximal length pseudorandom (PN) code time-shifted by a respective one of a plurality of time-shifts (c) encoded with a respective one of a plurality of codes, wherein a product of any two of the plurality of codes is a distinct code;
detecting a time-varying signal backscattered by the object in response to illumination by the plurality of mutually coherent beams;
extracting amplitudes and phases of at least one of (i) interferometric temporal beat note oscillation frequencies of the time-varying signal and (ii) circulant complex code correlations of the time-varying signal, the amplitudes and phases corresponding to selected Fourier components of the object's 3D Fourier representation; and
producing a range-resolved image of the object by applying a complex-valued weight to each of the selected Fourier components and applying a Fourier synthesis method to the weighted Fourier components, the range-resolved image having a depth resolution substantially determined by the collective bandwidth and a transverse resolution substantially determined by a maximum spatial separation between any two of a plurality of emitters of the emitter array.

2. The method of claim 1, illuminating the object comprising:
emitting each of the plurality of mutually coherent beams from a respective one of the plurality of emitters such that, at the object, each beam of the plurality of mutually coherent beams at least partially overlaps with another beam of the plurality of mutually coherent beams, thereby producing interferometric intensity fringes propagating away from the emitter array.

3. The method of claim 1, the emitter array including a first emitter and a second emitter displaced from the first emitter by Δx in a first direction and Δy in a second direction perpendicular thereto, and further comprising:
generating, with the first emitter, a first beam of the plurality of mutually coherent beams having a first carrier frequency (c/λ+f₁), where c is the speed of light and λ is a reference wavelength;
generating, with the second emitter, a second beam of the plurality of mutually coherent beams having a second carrier frequency (c/λ+f₂); and
pair-wise interfering the first beam and the second beam at a distance z₀ from the emitter array to produce a propagating sinusoidally-modulated intensity-fringe pattern propagating at a wave group velocity c_{g} and incident onto the object;
the selected Fourier components including 3D Fourier components (u, v, w) of the object having transverse components u= [symbol] x/λzₒ, v= [symbol] y/λzₒ, and a longitudinal component w=(f₁−f₂)/(c_{g}/2), at least one of [symbol] x and [symbol] y being non-zero.

4. The method of claim 1, the selected Fourier components being N(N−1) in number, the plurality of mutually coherent beams being N in number, the plurality of traveling-wave interference fringes being N (N−1)/2 in number, such that the step of illuminating includes:
illuminating the object with the N mutually coherent beams simultaneously, thereby measuring the N(N−1) Fourier components in parallel.

5. The method of claim 1, each of the plurality of codes being a respective time-shifted copy of a maximal-length pseudorandom noise (PN) code, said step of extracting amplitudes and phases comprising:
extracting amplitudes and phases of the circulant complex code correlations of the time-varying signal via PN code correlation and a rearrangement of the correlation peaks based on the shift-and-add property.

6. The method of claim 1, each of the plurality of codes being different binary phase-shift keyed (BPSK) encoded PN codes, the time-varying signal including Gold codes, said step of extracting amplitudes and phases comprising:
extracting the amplitudes and phases using a bank of Gold code correlators.

7. The method of claim 1, producing the range-resolved image comprising
processing the selected Fourier components at least in part via a complex coefficient retrieval method that utilizes known or estimated features of at least one of the object and its Fourier transform.

8. The method of claim 7, further comprising,
calibrating at least one of the amplitudes and phases of the plurality of mutually coherent beams using a complex coefficient retrieval method.

9. The method of claim 1, extracting amplitudes and phases including extracting, with a temporal Fourier transform, amplitudes and phases of the interferometric temporal beat note oscillation frequencies.

10. The method of claim 1, the plurality of coherent beams being N in number and each having a respective one of N distinct carrier frequencies f₁, f₂, . . . , f_{N} that are non-redundant, such that each frequency difference (fᵢ−fⱼ) between any two of N(N−1)/2 pairs of carrier frequencies is unique, wherein each of indices i and j is less than or equal to N and i≠j.

11. The method of claim 1, the emitter array including at least one of a spatial non-redundant group of emitters and a sparse group of emitters, the emitter array including a plurality of emitters, and further comprising
producing the plurality of mutually coherent beams such that each pair of emitters produce a pair of mutually coherent beams, of the plurality of mutually coherent beams, having a distinct frequency difference from every other pair of mutually coherent beams of the plurality of mutually coherent beams.

12. The method of claim 1, further comprising modulating each of the PN-codes onto a respective one of the plurality of coherent beams respectively via a binary-phase-shift-key (BPSK) scheme.

13. The method of claim 1, in the step of detecting, the time-varying signal being a single time-varying signal.

14. The method of claim 1, further comprising phase-calibrating a pair of the plurality of mutually coherent beams by establishing, at an instant in time, a specific phase offset between the pair of the plurality of mutually coherent beams.

15. The method of claim 1, the selected Fourier components being N(N−1) in number, the plurality of mutually coherent beams being N in number, and the plurality of traveling-wave interference fringes being N (N−1)/2 in number, and further comprising:
illuminating the object with an additional plurality of mutually coherent beams, which is one of (a) a permutation of the plurality of mutually coherent beams and (b) a second plurality of mutually coherent beams;
detecting an additional time-varying signal, scattered by the object in response to illumination by the additional plurality of mutually coherent beams, and including additional interferometric products of multiple pairs of the additional plurality of coherent beams;
extracting additional amplitudes and additional phases of temporal oscillations of the additional time-varying signal; and
appending the additional amplitudes and additional phases as additional components of the selected Fourier components such that the 3D Fourier representation includes as many as 2N(N−1) Fourier components,
said step of producing including producing a range-resolved image of the object via Fourier synthesis of the 3D Fourier representation.

16. The method of claim 15, the second plurality of mutually coherent beams being one of (i) a rotated version of the plurality of mutually coherent beams, (ii) a flipped version of the plurality of mutually coherent beams, and (iii) a different 2D non-redundant array (NRA) embedded within the Nₓ×N_{y} array of emitters with all the emitters addressed by a permuted version of the set of non-redundantly spaced frequencies or a different set of non-redundantly spaced frequencies.

17. The method of claim 15, further comprising:
producing the plurality of mutually coherent beams with the emitter array, the emitter array being addressed by a set of non-redundantly spaced frequencies; and
producing the second plurality of mutually coherent beams with the emitter array, the emitter array being addressed by either a permuted version of the set of non-redundantly spaced frequencies or a distinct and different set of non-redundantly spaced frequencies.

18. The method of claim 15, the 3D Fourier representation having dimensions Nₓ×N_{y}×N_{z}, and further comprising repeating claim 15's steps of illuminating, detecting, extracting, and appending a total number of times equal to an integer Q, such that the resulting 3D Fourier representation includes as many as QN(N−1) distinct complex non-zero 3D Fourier components scattered throughout the Nₓ×N_{y}×N_{z} 3D Fourier representation since some of the sparse samples may overlap.

19. A range-resolved imaging method comprising:
sampling a plurality of 3D Fourier components of a target with a plurality of frequency-shifted beams that pair-wise interfere at the target, each of the plurality of frequency-shifted beams having been emitted by a respective transmitter of a sparse transmitter-array;
extracting amplitudes and phases of temporal oscillations of a detected signal back-scattered by the target in response to the pair-wise interference of the plurality of frequency-shifted beams, the amplitudes and phases corresponding to selected 3D Fourier components of a plurality of temporal Fourier components of the detected signal;
assembling the amplitudes and the phases in a 3D spatial-frequency representation; and
producing a range-resolved image of the target via Fourier synthesis of the 3D Fourier representation.

20. A range-resolved imager comprising:
an emitter array that illuminates a scene with a plurality of mutually coherent beams;
a detector that detects a backscattered signal scattered by an object in the scene and propagating toward the detector;
a processor; and
a memory storing machine readable instructions that when executed by the processor, control the processor to execute the method of claim 1.

21. The imager of claim 20, the emitter array including at least three emitters that form a non-redundant array, each pair of emitters of the non-redundant array being separated by a respective distance that differs from a respective distance between each other pair of emitters of the non-redundant array.

22. The imager of claim 20, the emitter array being one of a sparse array and a minimally-redundant array.

23. The imager of claim 20, the emitter array including a plurality of emitters, each being one of: a tile of serpentine optical phased array (SOPA) 2D wavelength beamsteering tiles with grating couplers on successive rows, an optical phased array, a microelectromechanical system (MEMS), a spatial light modulator (SLM), a deformable micromirror device (DMD), a telescope, an optical fiber, a photonic integrated circuit (PIC) with one of an edge-coupler and a grating-coupler, an acoustic transducer, optical emitter of mutually coherent light, a radiofrequency emitter, a microwave emitter, and an acoustic emitter.

24. The imager of claim 20, the detector being one of (i) an integrating incoherent receiver, (ii) an array of current summed serpentine optical phased array (SOPA) receiver tiles incorporating wideband waveguide detectors in each tile, and (iii) a wideband summed output of a detector array.
